(19) United States
(12) Patent Application Publication
(10) Pub. No.: US 2015/0028142 A1
(43) Pub. Date: Jan. 29, 2015

(54) QUICKLY RELEASABLE LINER BOLT

(71) Applicant: Donhad Pty Ltd, Bassendean (AU)

(72) Inventor: Dale Coray, Bali (ID)

(21) Appl. No.: 14/376,721

(22) PCT Filed: Feb. 6, 2013
(86) PCT No.: PCT/AU2013/000093

§ 371 Date: Aug. 5, 2014

(30) Foreign Application Priority Data
Feb. 6, 2012 (AU) 2012900419

(51) Int. Cl. B02C 17/22; F16B 33/02; F16B 33/00; B02C 23/00

(52) U.S. Cl. CPC B02C 17/22; B02C 23/00; F16B 33/02; F16B 33/00
USPC 241/300; 29/525.02; 29/426.5; 411/427; 411/411; 411/337

(57) ABSTRACT

A nut (23) and a re-usable liner bolt (17) for a grinding mill is disclosed. The nut is shaped to be received in the recess (5) of a mill liner plate (3), this being the recess which normally receives the head of a conventional liner bolt. The nut is provided with a blind threaded hole (25). The re-usable bolt has a stepped shank (18) and a thread (20) on its free end. The bolt (17) is inserted from the exterior of the mill and engages the nut (23). The fines produced during grinding cement the nut to the liner but do not cement the bolt to the liner or the bolt to the nut. The head of a conventional liner bolt is located within the mill and its conventional nut is located exterior of the mill, whereas the re-usable bolt (17) has its head exterior of the mill and its nut (23) interior of the mill. Methods of assembly and dis-assembly of the bolt (17) and nut (23) are also disclosed.

### FIELD OF THE INVENTION

The present invention relates to grinding mills and, in particular to the liner bolts used to secure the sacrificial liners of such mills.

### BACKGROUND ART

Grinding mills are used in a wide range of mining activities such as the milling of hard rock ores, including copper ore, the production of cement, and other such activities. Typically the mill consists of a hollow steel cylinder which is rotated about its longitudinal axis. The interior of the cylinder is lined with the sacrificial liner. Inside the liner are the lumps of ore and the grinding bodies, such as steel balls. As the mill is rotated, so the grinding bodies grind the lumps of ore up into a fine powder which is then utilised in the next stage of the process.

During routine maintenance, it is necessary to replace the sacrificial lining with a new lining. Since the sacrificial lining is bolted to the mill body, this replacement task normally requires the bolts holding the lining in place to be knocked out by means of hydraulic hammers, pneumatic hammers, manually operated hammers, or suspended hammering devices similar to a battering ram. Approximately 30% of the time spent in doing a re-line of a grinding mill is spent in removing the liner bolts holding the worn liner in place. Typically 4-6 personnel are employed in this job.

### GENESIS OF THE INVENTION

The genesis of the present invention is a desire to reduce the amount of effort required to change the sacrificial lining.

### SUMMARY OF THE INVENTION

In accordance with a first aspect of the present invention there is disclosed a liner nut having an exterior surface and a blind threaded hole, said exterior surface being shaped to mate with a recess in a grinding mill liner plate to thereby prevent rotation of said nut relative to said recess, said blind threaded hole being located in a protruding portion of said nut which is dimensioned to extend through said liner plate recess and beyond said liner plate.

In accordance with a second aspect of the present invention there is disclosed a liner bolt having a head, a shank extending from said head and having a transverse extent less than the transverse extent of said head, and a threaded portion of said shank adapted to threadably engage with the threaded blind hole of the abovementioned liner nut, the length of said threaded portion not exceeding the length of said protruding portion.

In accordance with a third aspect of the present invention there is disclosed the combination of the above-mentioned liner nut and liner bolt.

According to another aspect of the present invention there is provided a method of assembling a liner plate having a shaped recess therein to a mill wall having a through aperture, said method comprising the steps of:

aligning said recess and aperture,

inserting a liner nut as defined above into said recess such that said protruding portion extends into said aperture to maintain said recess and aperture aligned,

inserting the shank of a liner bolt as defined above into said blind hole,

and threadably engaging the thread of said shank with the thread of said blind hole in said liner nut.

According to a still further aspect of the present invention there is provided a method of disassembling a liner plate from a mill wall having a through aperture, said liner plate being held against said wall by means of a liner nut as defined above, being retained in a recess of said liner plate, and a liner bolt as defined above extending into said liner nut protrusion, said method comprising the steps of:

rotating the head of said liner bolt to disengage the threaded shank thereof from the thread of the blind hole of said liner nut,

discarding said liner plate and liner nut, and

retaining said liner bolt for use in the subsequent assembly of a new liner plate to said mill wall.

According to a yet still further aspect of the present invention there is provided a nut and bolt system to maintain assembled a liner plate on a grinding mill wall, said liner plate having a first through aperture opening into a recess, said mill wall having a second through aperture with said first aperture being aligned with said second aperture; said nut and bolt system comprising:

a liner nut having an exterior surface shaped to mate with said liner plate recess to thereby prevent rotation of said nut relative to said recess, said liner nut further having a protruding portion which is dimension to extend through said recess and first aperture and into said second aperture to maintain said first and second apertures aligned, said protruding portion having a blind threaded hole,

said liner nut further having a protruding portion which is dimensioned to extend through said recess and first aperture and into said second aperture to maintain said first and second apertures aligned, said protruding portion having a blind threaded hole,

a liner bolt having an elongate shank with two ends, one of said ends terminating in a head having a transverse dimension greater than said shank and being shaped to be engageable with a tool to permit said bolt to be rotated, said shank having a transverse dimension less than the size of said first and second apertures to permit said shank to pass therethrough, and the other of said shank ends being threaded and being threadably engaged with said nut such that said head bears against one side of said mill wall to hold said liner plate against the other side of said mill wall;

wherein operation of said grinding mill wears said liner plate requiring eventual replacement of said liner plate and producing fines which enter said recess and cement said nut to said recess, and

wherein said bolt can be rotated to disengage said shank from said cemented nut to permit said bolt to be withdrawn from said mill wall, said liner plate with liner nut cemented thereto being discarded and said liner bolt being retained for engagement with a second liner nut and second liner plate to retain the same newly assembled with said mill wall.

### BRIEF DESCRIPTION OF THE DRAWINGS

A preferred embodiment of the invention will now be described, by way of example only, with reference to the accompanying drawings in which:

FIG. 1 is an exploded cross-sectional view taken through the cylindrical wall of a prior art grinding mill and showing a prior art nut and bolt which retains the liner in place,

FIG. 2 is an end elevation of the head of the bolt of FIG. 1;

FIG. 3 is a cross-sectional view equivalent to FIG. 1 but in accordance with a preferred embodiment of the present invention;

FIG. 4 is an end elevation of the nut of FIG. 3; and

FIG. 5 is a combined side elevation and end view of a bolt of a second embodiment.

### DETAILED DESCRIPTION

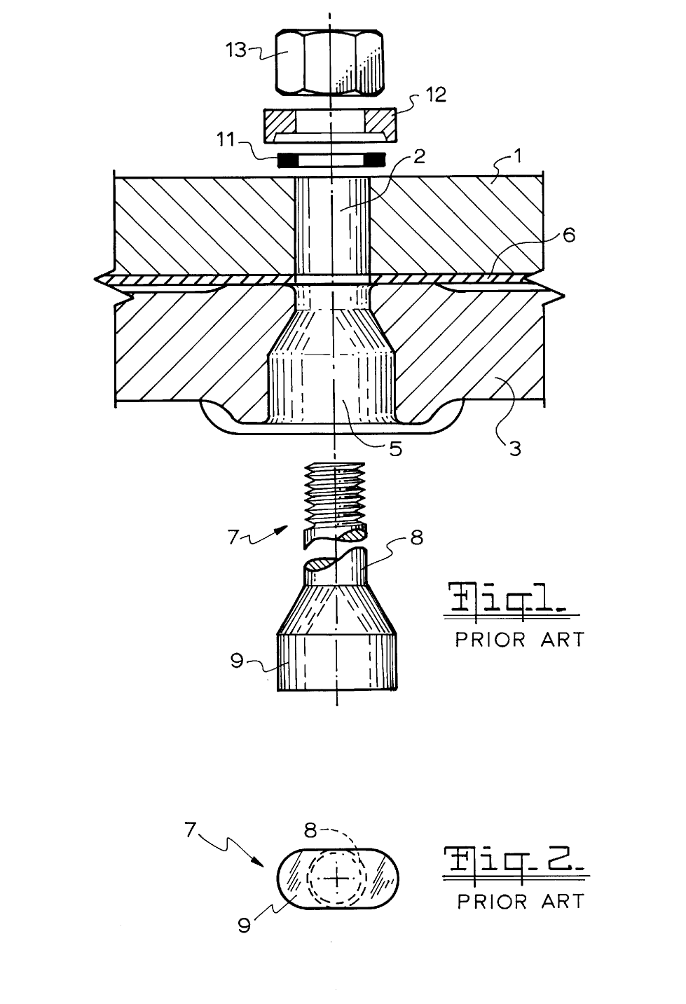

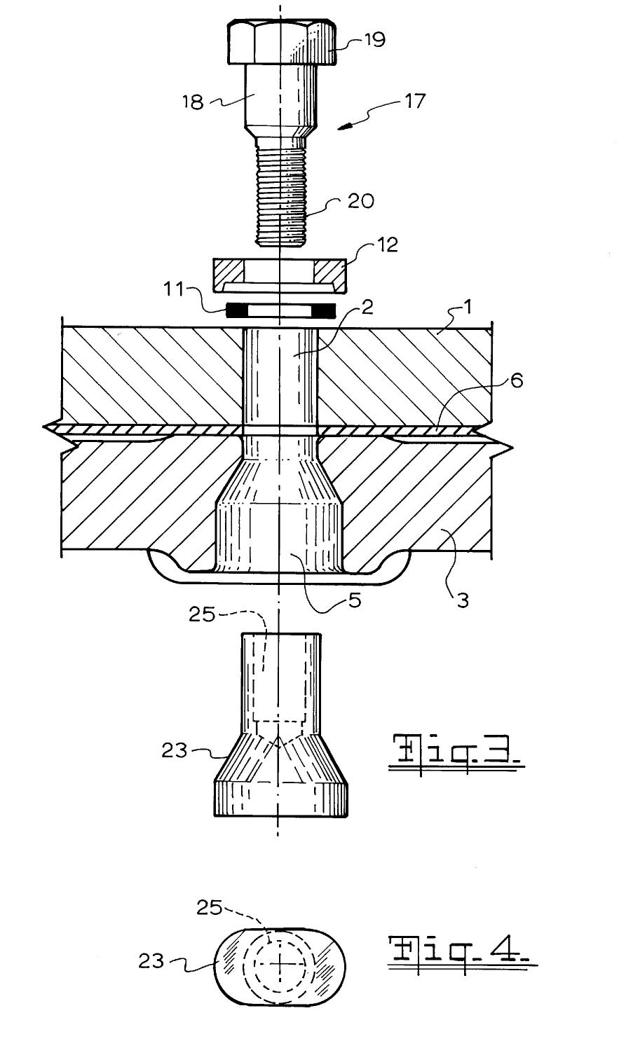

As seen in FIGS. 1 and 2, a mill wall 1 has an aperture 2 therethrough. A liner plate 3 and rubber backing sheet 6 are positioned adjacent the mill wall 1. The liner plate 3 and has a shaped recess 5 which opens towards the interior of the mill. The recess 5 extends through the liner plate 3 and is aligned with the aperture 2. A conventional liner bolt 7 has a shank 8 and a head 9. The tip of the shank 8 is threaded in conventional fashion. The head 9 has a generally oval shape and mates with the recess 5 so as to stop the liner bolt 7 rotating within the recess 5.

In order to secure the liner plate 3, the liner bolt 7 is passed into the recess 5 and through the aperture 2, a rubber washer 11 and a steel washer 12 are then passed over the shank 8, and a conventional nut 13 secured to the thread. Tightening the nut 13 clamps the liner plate 3 against the mill wall 1.

After several months, when the liner plate 3 comes to be replaced, the nut 13 and washers 11, 12 are removed from the liner bolt 7. Then the bolt 7 is knocked out of the aperture 2 and liner plate 3. This is a very time-consuming task which requires manually guided hammers and numerous people. Since the threaded portion of the shank 8 protrudes from the nut 13, the threads on the shank 8 become corroded due to their exposure to the elements, and thus the nut 13 quite often requires cutting off with an oxyacetylene torch, rather than being removed with a pneumatic wrench, or similar. In addition, due to wear and peening of the bolt head, and hammer impacts on the bolt shank 8, the bolt can become deformed, thus making the bolts 7 difficult to remove and also causing damage to the apertures 2 in the mill wall 1.

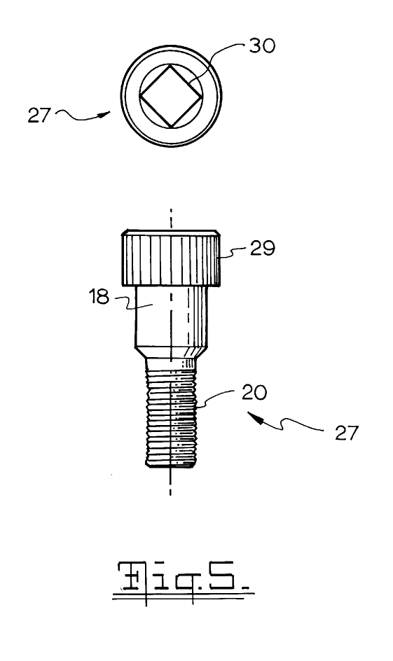

Turning now to FIGS. 3 and 4, the mill wall 1, liner plate 3, rubber backing sheet 6, and washers 11, 12 are as before. However, the liner bolt 17 has its orientation reversed. The liner bolt 17 has a shank 18 and a head 19 and a threaded portion 20 which is of reduced diameter relative to the shank 18. A liner nut 23 has an exterior shape (for example oval when viewed end on) designed to exactly match the recess 5 and thus corresponds in shape to the head 9 of the conventional liner bolt 7 of FIG. 1. As a consequence, the liner nut 23 cannot rotate within the recess 5. The liner nut 23 is also provided with a blind hole 25 within a protruding portion. The blind hole 25 is threaded with a thread which matches that of the threaded portion 20.

During installation, the liner plate 3 has the recess 5 aligned with the corresponding aperture 2, and the liner nut 23 is positioned into the recess 5. Thus the protruding portion of the nut 23 extends into the aperture 2, and is preferably approximately flush with the exterior surface of the mill wall 1. The shank 18 of the liner bolt 17 is inserted into the blind hole 25 and the liner bolt 17 is rotated, preferably using an impact gun or similar, to engage the threaded portion 20 with the blind hole 25 in the liner nut 23. This engagement brings the liner plate 3 into contact with the mill wall 1 and holds the liner plate 3 in a stable position.

The liner bolt 17 and liner nut 23 are designed so that there is no need to knock out the liner bolt 17 prior to removal of the liner plate 3 during routine maintenance. As the male thread of the threaded portion 20 and the female thread of the blind hole 25 are both protected within the mill wall aperture 2, this eliminates the possibility of them becoming seized, for example because of fines or ore dust entering the thread as happens with the conventional arrangement of FIG. 1. Thus there is no need for any cutting equipment. Instead, the liner bolt 17 can be undone using a conventional pneumatic wrench, for example.

There is no need to remove the liner nut 23 from the liner plate 3 since the liner plate 3 is to be discarded. The liner nut 23 will normally be “cemented” into the recess 5 by the penetration of fine ore dust around the liner nut 23. The presence of the rubber backing sheet 6 normally prevents fines entering the aperture 2 in the mill wall 1. It is this “cementing action” which requires the conventional liner bolt 7 to be hammered out of the recess 5. However, the reversal of the direction of the liner bolt 17 overcomes the problems caused by this “cementing action” since the nut 23 is cemented only to the liner plate 3 but not to the mill wall 1.

Furthermore, the liner bolt 17 is reusable because it is undamaged from the removal process. In particular it has not been hammered or peened. Although the liner bolt 17 and the liner nut 23 can both be manufactured of the same grade steel, if the liner bolt 17 is manufactured with a higher grade steel, it is reusable on more occasions.

As seen in FIG. 5, an alternative form of liner bolt 27 has a head 29 with an internal square drive recess 30.

The foregoing describes only some embodiments of the present invention and modifications, obvious to those skilled in the mining arts, can be made thereto without departing from the scope of the present invention. For example, the axial length of the liner bolt 17 and liner nut 23 can be varied to suit the thicknesses of the mill wall 1 and the liner plate 3. Preferably, the shank 18 and blind hole 25 are provided with 6 threads per inch, however, this can be modified depending upon the mill structure thickness and clamping force required the different sized wear liners. In addition, the nut 23 can be of any shape with the recess 5 of the mill liner plate 3 having a corresponding complementary shape.

The term “comprising” (and its grammatical variations) as used herein is used in the inclusive sense of “including” or “having” and not in the exclusive sense of “consisting only of”.

1. A liner nut having an exterior surface and a blind threaded hole, said exterior surface being shaped to mate with a recess in a grinding mill liner plate to thereby prevent rotation of said nut relative to said recess, said blind threaded hole being located in a protruding portion of said nut which is dimensioned to extend through said liner plate recess and beyond said liner plate.

2. The liner nut as claimed in claim 1 wherein said exterior surface has the shape of the head of a liner bolt previously received in said recess.

3. The liner nut as claimed in claim 1 wherein said exterior surface is substantially oval.

4. A liner bolt having a head, a shank extending from said head and having a transverse extend less than the transverse extend of said head, and a threaded portion of said shank adapted to threadably engage with the threaded blind hole of the liner nut as claimed in claim 1, the length of said threaded portion not exceeding the length of said protruding portion.

5. The liner bolt as claimed in claim 4 and having a head with an internal drive recess.

6. The combination of a liner nut having an exterior surface and a blind threaded hole, said exterior surface being shaped to mate with a recess in a grinding mill liner plate to thereby prevent rotation of said nut relative to said recess, said blind threaded hole being located in a protruding portion of said nut which is dimensioned to extend through said liner plate recess and beyond said liner plate and a liner bolt as claimed in claim 4.

7. A method of assembling a liner plate having a shaped recess therein to a mill wall having a through aperture, said method comprising the steps of:
aligning said recess and aperture,
inserting a liner nut having an exterior surface and a blind threaded hole, said exterior surface being shaped to mate with a recess in a grinding mill liner plate to thereby prevent rotation of said nut relative to said recess, said blind threaded hole being located in a protruding portion of said nut which is dimensioned to extend through said liner plate recess and beyond said liner plate into said recess such that said protruding portion extends into said aperture to maintain said recess and aperture aligned,
inserting the shank of a liner bolt as claimed in claim 4 into said blind hole, and
threadably engaging the thread of said shank with the thread of said blind hole in said liner nut.

8. A method of disassembling a liner plate from a mill wall having a through aperture, said liner plate being held against said wall by means of a liner nut having an exterior surface and a blind threaded hole, said exterior surface being shaped to mate with a recess in a grinding mill liner plate to thereby prevent rotation of said nut relative to said recess, said blind threaded hole being located in a protruding portion of said nut which is dimensioned to extend through said liner plate recess and beyond said liner plate being retained in a recess of said liner plate, and a liner bolt as claimed in claim 4 extending into said liner nut protrusion, said method comprising the steps of:
rotating the head of said liner bolt to disengage the threaded shank thereof from the thread of the blind hole of said liner nut,
discarding said liner plate and liner nut, and
retaining said liner bolt for use in the subsequent assembly of a new liner plate to said mill wall.

9. A nut and bolt system to maintain assembled a liner plate on a grinding mill wall, said liner plate having a first through aperture opening into a recess, said mill wall having a second through aperture with said first aperture being aligned with said second aperture; said nut and bolt system comprising:
a liner nut having an exterior surface shaped to mate with said liner plate recess to thereby prevent rotation of said nut relative to said recess, said liner nut further having a protruding portion which is dimension to extend through said recess and first aperture and into said second aperture to maintain said first and second apertures aligned, said protruding portion having a blind threaded hole,
said liner nut further having a protruding portion which is dimensioned to extend through said recess and first aperture and into said second aperture to maintain said first and second apertures aligned, said protruding portion having a blind threaded hole,
a liner bolt having an elongate shank with two ends, one of said ends terminating in a head having a transverse dimension greater than said shank and being shaped to be engageable with a tool to permit said bolt to be rotated, said shank having a transverse dimension less than the size of said first and second apertures to permit said shank to pass therethrough, and the other of said shank ends being threaded and being threadably engaged with said nut such that said head bears against one side of said mill wall to hold said liner plate against the other side of said mill wall;
wherein operation of said grinding mill wears said liner plate requiring eventual replacement of said liner plate and producing fines which enter said recess and cement said nut to said recess, and
wherein said bolt can be rotated to disengage said shank from said cemented nut to permit said bolt to be withdrawn from said mill wall, said liner plate with liner nut cemented thereto being discarded and said liner bolt being retained for engagement with a second liner nut and second liner plate to retain the same newly assembled with said mill wall.

10. The liner nut as claimed in claim 2 wherein said exterior surface is substantially oval.

11. A liner bolt having a head, a shank extending from said head and having a transverse extend less than the transverse extend of said head, and a threaded portion of said shank adapted to threadably engage with the threaded blind hole of the liner nut as claimed in claim 2, the length of said threaded portion not exceeding the length of said protruding portion.

12. The liner bolt as claimed in claim 11 and having a head with an internal drive recess.

13. A liner bolt having a head, a shank extending from said head and having a transverse extend less than the transverse extend of said head, and a threaded portion of said shank adapted to threadably engage with the threaded blind hole of the liner nut as claimed in claim 3, the length of said threaded portion not exceeding the length of said protruding portion.

14. The liner bolt as claimed in claim 13 and having a head with an internal drive recess.

15. The combination of a liner nut having an exterior surface and a blind threaded hole, said exterior surface being shaped to mate with a recess in a grinding mill liner plate to thereby prevent rotation of said nut relative to said recess, said blind threaded hole being located in a protruding portion of said nut which is dimensioned to extend through said liner plate recess and beyond said liner plate and a liner bolt as claimed in claim 5.

16. A method of assembling a liner plate having a shaped recess therein to a mill wall having a through aperture, said method comprising the steps of:
aligning said recess and aperture,
inserting a liner nut having an exterior surface and a blind threaded hole, said exterior surface being shaped to mate with a recess in a grinding mill liner plate to thereby prevent rotation of said nut relative to said recess, said blind threaded hole being located in a protruding portion of said nut which is dimensioned to extend through said liner plate recess and beyond said liner plate into said recess such that said protruding portion extends into said aperture to maintain said recess and aperture aligned,
inserting the shank of a liner bolt as claimed in claim 5 into said blind hole, and
threadably engaging the thread of said shank with the thread of said blind hole in said liner nut.

17. A method of disassembling a liner plate from a mill wall having a through aperture, said liner plate being held against said wall by means of a liner nut having an exterior surface and a blind threaded hole, said exterior surface being shaped to mate with a recess in a grinding mill liner plate to thereby prevent rotation of said nut relative to said recess, said blind threaded hole being located in a protruding portion of said nut which is dimensioned to extend through said liner plate recess and beyond said liner plate being retained in a recess of said liner plate, and a liner bolt as claimed in claim 5 extending into said liner nut protrusion, said method comprising the steps of:
rotating the head of said liner bolt to disengage the threaded shank thereof from the thread of the blind hole of said liner nut,
discarding said liner plate and liner nut, and
retaining said liner bolt for use in the subsequent assembly of a new liner plate to said mill wall.

18. The combination of a liner nut and liner bolt according to claim 6, wherein said exterior surface of said liner nut has the shape of the head of said liner bolt previously received in said recess.

19. The combination of a liner nut and liner bolt according to claim 18, wherein said exterior surface of said liner nut is substantially oval.

20. The combination of a liner nut and liner bolt according to claim 6, wherein said exterior surface of said liner nut is substantially oval.
